(19) United States
(12) Patent Application Publication
(10) Pub. No.: US 2018/0052641 A1
(43) Pub. Date: Feb. 22, 2018

(54) INFORMATION PROCESSING APPARATUS AND INFORMATION PROCESSING METHOD

(71) Applicant: FUJITSU LIMITED, Kawasaki-shi (JP)

(72) Inventors: SHINHO HAYASHI, Kawasaki (JP); Mikio Morita, Kawasaki (JP); Takeaki Kato, Kawasaki (JP)

(73) Assignee: FUJITSU LIMITED, Kawasaki-shi (JP)

(21) Appl. No.: 15/665,479

(22) Filed: Aug. 1, 2017

(30) Foreign Application Priority Data
Aug. 22, 2016 (JP) 2016-162178

(51) Int. Cl. G06F 3/06

(52) U.S. Cl. CPC G06F 3/0689; G06F 2212/205; G06F 3/0688

(57) ABSTRACT

An information processing apparatus including a plurality of slots into which a storage device container including a storage device and a first memory that stores first position information representing a slot to which the storage device is to be attached is inserted, a second memory that stores configuration information including second position information representing a slot into which the storage device has been attached, a controller that compares the first position information and the second position information and determines whether or not the storage device has been attached to a slot represented by the first position information, on a basis of a comparison result, and a processor that outputs the first position information when the storage device has not been attached to a slot represented by the first position information.

### CROSS-REFERENCE TO RELATED APPLICATION

This application is based upon and claims the benefit of priority of the prior Japanese Patent Application No. 2016-162178, filed on Aug. 22, 2016, the entire contents of which are incorporated herein by reference.

### FIELD

The embodiments discussed herein are related to an information processing apparatus and an information processing method.

### BACKGROUND

As a method of operating a hard disk drive (HDD) in a server, Redundant Arrays of Inexpensive Disks (RAID) is known in which a plurality of HDDs are identified and displayed as a single HDD in order to increase the redundancy.

For servers for example, RAID5, which is a type of RAID, is used. RAID5 is a scheme in which pieces of data and error correction codes (parity data) are written to three or more HDDs in a distributed manner.

FIG. 1 illustrates an example of RAID5.

In FIG. 1, a RAID controller 11 uses four HDDs 12-1 through 12-4 so as to constitute RAID5. For example, when data is written, that data is divided into a plurality of pieces of data A through I. Data A, data B and data C are written to the HDDs 12-1 through 12-3, respectively, parity data p-ABC, which is error correction code of data A through data C, is written to the HDD 12-4. Also, data D, data E and data F are written to the HDDs 12-1, 12-2 and 12-4, respectively, and parity data p-DEF of data D through F is written to the HDD 12-3. Also, data G, data H and data I are written to the HDDs 12-1, 12-3 and 12-4, respectively, and parity data p-GHI, which is error correction code of data G through I, is written to the HDD 12-2.

A technique is known that displays erroneous implementation of a channel board in a transmission device etc. in which a plurality of types of channel boards are implemented (see Patent Document 1 for example).

Also, a technique is known that detects erroneous installation of a storage device to a controller without the need to install additional components between the storage device and the controller (see Patent Document 2 for example).

As a function of RAID5, there is rebuild, which implements a new HDD in place of a failed HDD so as to restore the information of the HDD when one of a plurality of HDDs constituting a RAID group has failed.

A RAID controller that performs rebuild does not determine whether an HDD that has been newly mounted is an HDD mounted for the rebuild or an HDD that has been mounted erroneously by maintenance personnel. Accordingly, when an HDD storing information that is different from information stored on the basis of RAID5 is mounted, rebuild is automatically performed and stored data is deleted unintentionally.

### Document 1: Japanese Laid-open Patent Publication No. 4-57140

### Document 2: Japanese Laid-open Patent Publication No. 2011-145902

### Document 3: Japanese Laid-open Patent Publication No. 5-189103

### Document 4: Japanese Laid-open Patent Publication No. 2009-187123

### SUMMARY

According to an aspect of the invention, an information processing apparatus includes a plurality of slots, a second memory, a controller and a processor.

Into the plurality of slots, a storage device container including a storage device and a first memory that stores first position information representing a slot to which the storage device is to be attached is inserted.

The second memory stores configuration information including second position information representing a slot into which the storage device has been attached.

The controller compares the first position information and the second position information and determines whether or not the storage device has been attached to a slot represented by the first position information, on a basis of a comparison result.

The processor outputs the first position information when the storage device has not been attached to a slot represented by the first position information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of RAID5;

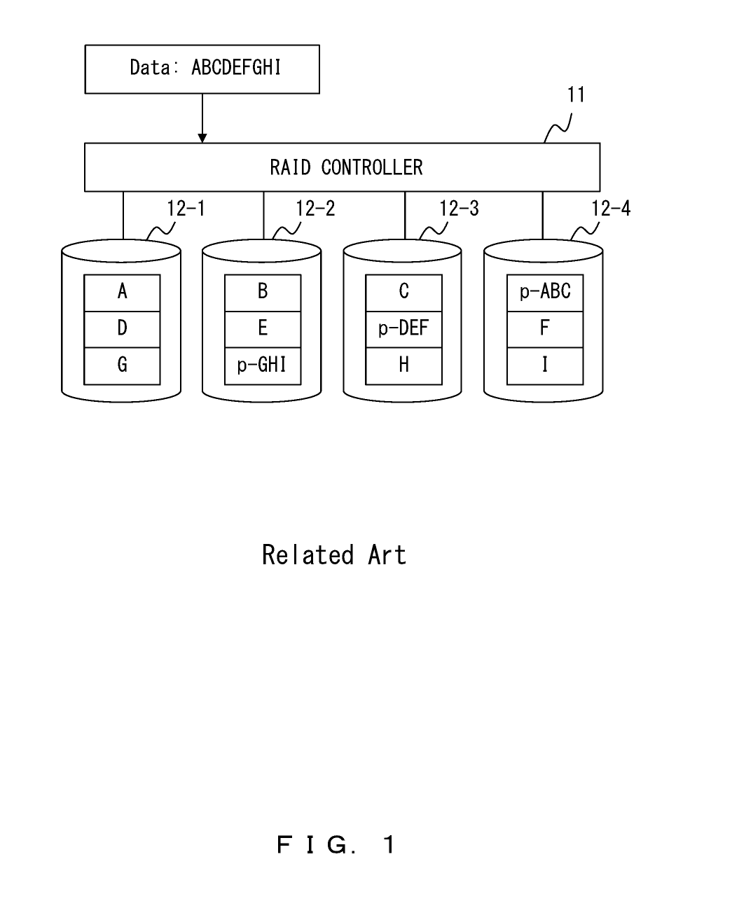

FIG. 2 illustrates an example of implementation of HDDs;

FIG. 3 illustrates an example in which HDDs are implemented erroneously;

FIG. 4 is a configuration diagram of a server according to the embodiments;

FIG. 5 is a configuration diagram of a node according to the embodiments;

FIG. 6 is another configuration diagram of a node according to the embodiments;

FIG. 7 is a configuration diagram of an HDD cage according to the embodiments;

FIG. 8 is a configuration diagram of an HDD unit according to the embodiments;

FIG. 9 illustrates an example of an HDD position table;

FIG. 10 illustrates an example of an HDD configuration table;

FIG. 11 illustrates a configuration example of an HDD;

FIG. 12 illustrates a sequence diagram of a process of a node according to the embodiments;

FIG. 13 illustrates an example of a display window in case of detection of erroneous implementation;

FIG. 14 illustrates an example of a display window in case of detection of insertion omission;

FIG. 15 is a flowchart of a check process according to the embodiments;

FIG. 16 is a flowchart of a display process according to the embodiments;

FIG. 17 is a flowchart of an update process according to the embodiments;

FIG. 18 illustrates the an HDD position table included in an HDD unit 1-2;

FIG. 19 illustrates an HDD position table included in an HDD unit 2-4;

FIG. 20 illustrates an HDD configuration table before maintenance;

FIG. 21 illustrates an HDD configuration table in case of detection of erroneous implementation;

FIG. 22 illustrates a display window in case of detection of erroneous implementation;

FIG. 23 illustrates an HDD configuration table before maintenance;

FIG. 24 illustrates an HDD configuration table in case of detection of insertion omission; and

FIG. 25 illustrates a display window in case of detection of insertion omission.

### DESCRIPTION OF EMBODIMENTS

First, an example will be described where data is unintentionally deleted by rebuild.

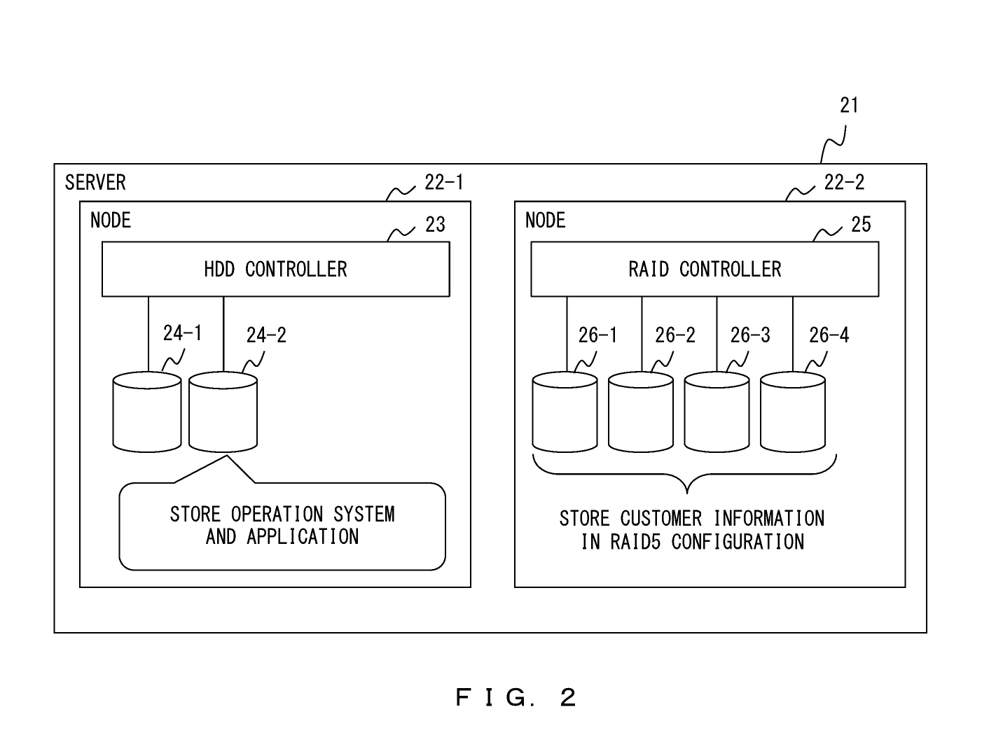

FIG. 2 illustrates an example of implementation of HDDs.

In FIG. FIG. 2 the server 21 is a multi-node server, and includes nodes 22-1 and 22-2.

The node 22-1 includes an HDD controller 23 and HDDs 24-1 and 24-2. To the HDD controller 23, the HDDs 24-1 and 24-2 are connected, and the HDD controller 23 controls the writing and the reading of data stored in the HDDs 24-1 and 24-2. The HDDs 24-1 and 24-2 store an operating system (OS) and an application program.

The node 22-2 includes the a RAID controller 25 and HDDs 26-1 through 26-4. To the RAID controller 25, the HDDs 26-1 through 26-4 are connected, and the RAID controller 25 controls the writing and the reading of data stored in the HDDs 26-1 through 26-4 and also controls RAID. In FIG. 2, the HDDs 26-1 through 26-4 constitute RAID5. The HDDs 26-1 through 26-4 store customer information.

It is assumed that that the HDDs 24-1, 24-2 and 26-1 through 26-4 are removed from the server 21 and the HDDs 24-1, 24-2 and 26-1 through 26-4 are attached to the original positions again for maintenance, replacement of components, etc. of the server 21, It is assumed that that the maintenance personnel attached HDDs to a wrong position.

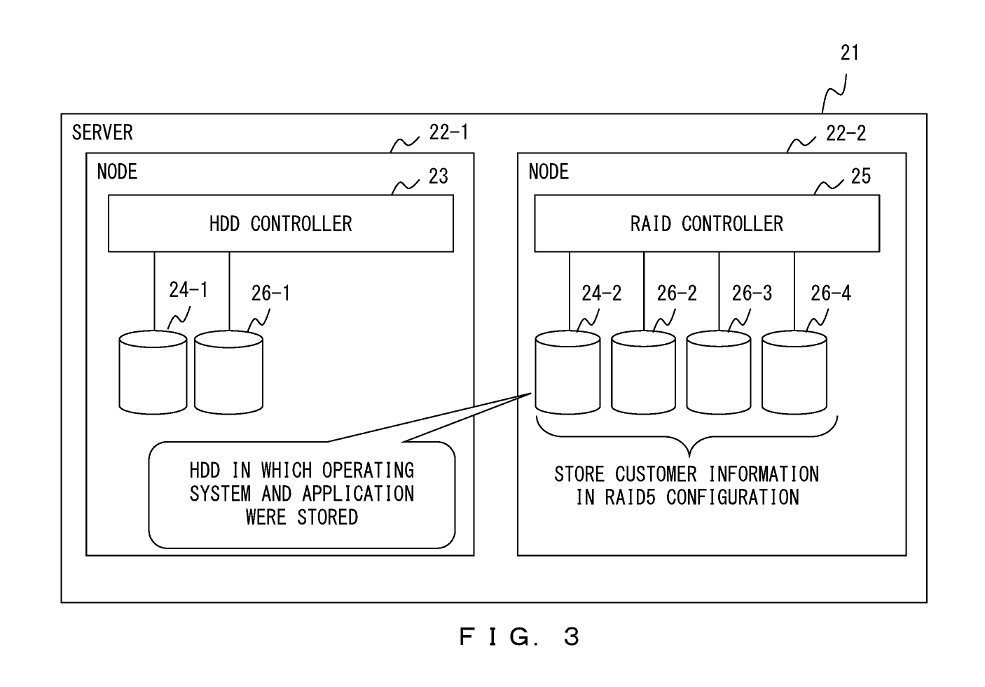

FIG. 3 illustrates an example in which HDDs are implemented erroneously.

In FIG. 3, the HDDs 24-2 and 26-1 have been attached to the contrarily positions compared to FIG. 2. When the power of the server 21 is turned on, the RAID controller 25 identifies the HDD 24-2 as an HDD that has replaced the HDD 26-1, and performs rebuild. Thereby, customer information stored in the HDD 26-1 is restored in the HDD 24-2 and the customer information is secured.

However, OSs and application programs stored in the HDD 24-2 are deleted.

Hereinafter, explanations will be given for the embodiments by referring to the drawings.

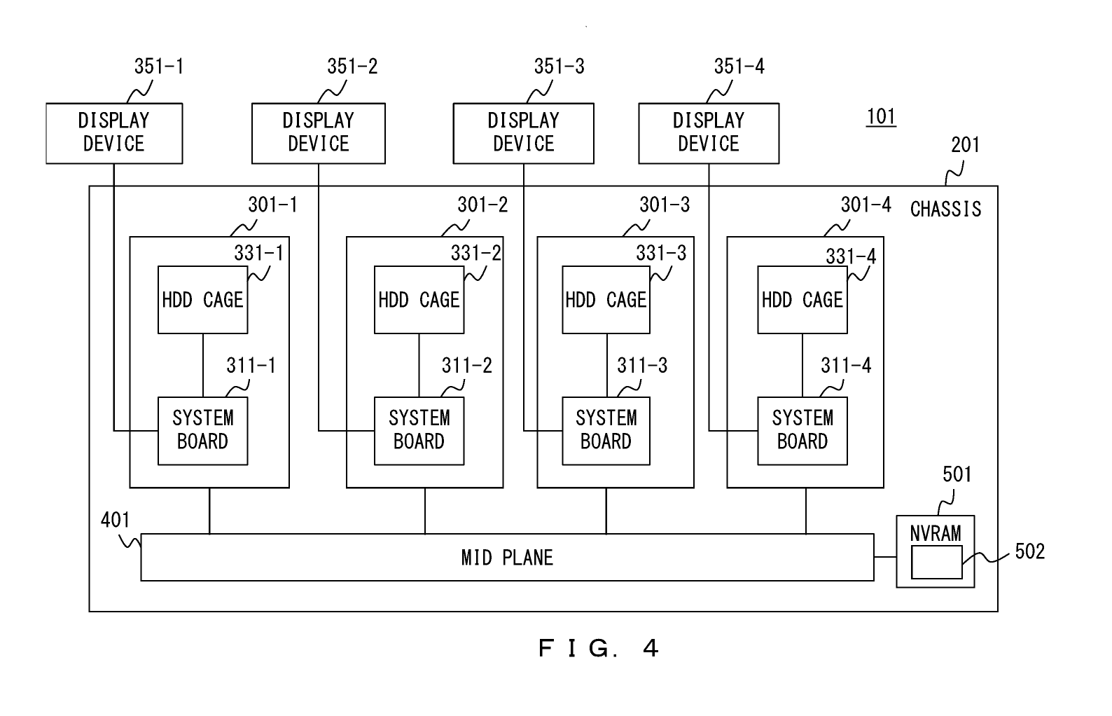

FIG. 4 is a configuration diagram of a server according to the embodiments.

A server 101 includes a chassis (housing) 201, nodes 301-i (i=1 through 4), a mid plane 401 and a Non Volatile Random Access Memory (NVRAM) 501.

The chassis 201 is a housing that accommodates the nodes 301-i.

The node 301-i includes a system board 311-i, an HDD cage 331-i and a display device 351-i.

The system board 311-i is a board on which components such as a CPU, a memory, etc. that execute various functions of the nodes 301-i are mounted.

The HDD cage 311-i is a device that can accommodate a plurality of HDD units.

The display device 351-i displays inquiries to the user or the maintenance personnel, the state of the node 301-i or results of various processes. The display device 351-i is for example a Liquid Crystal Display (LCD).

To the nodes 301-1 through 301-4, node numbers 1 through 4 are assigned, respectively. Hereinafter, the node 301-i may be referred to as node i.

The mid plane 401 is a circuit board that connects the node 301-i and the NVRM 501.

The NVRM 501 stores an HDD configuration table 502. In the HDD configuration table 502, information such as the configuration of HDDs mounted on the server 102, the types of RAID, etc. is described. The HDD configuration table 502 will be described later in detail. Also, the NVRM 501 stores the setting information of Baseboard Management Controller (BMC) and Basic Input/Output System (BIOS) of each node 301-i.

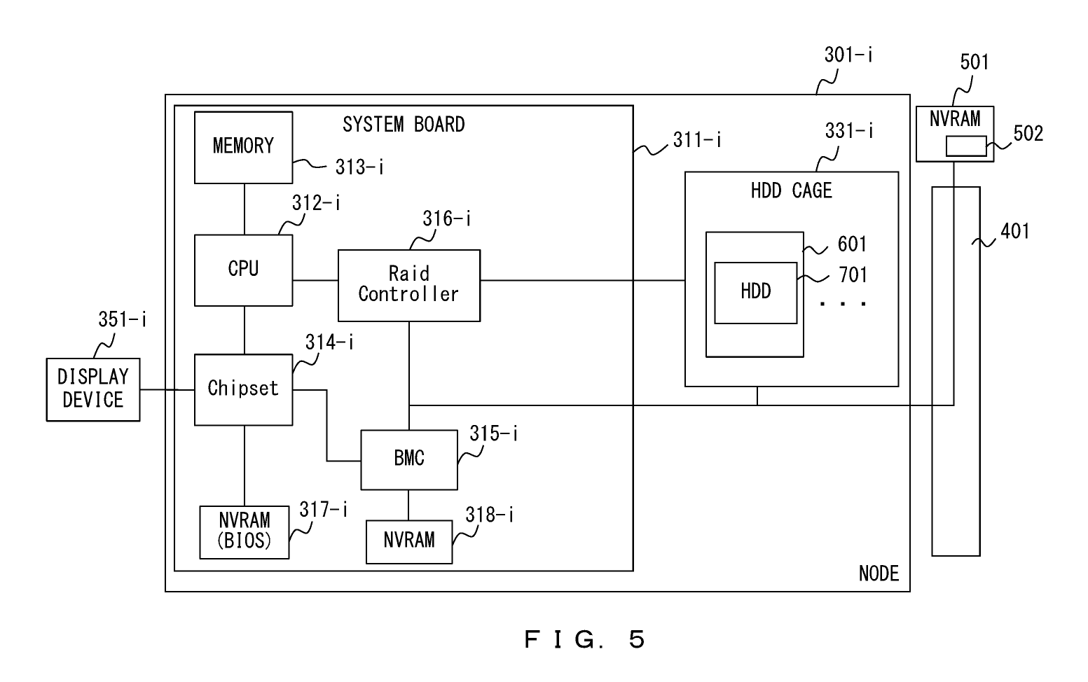

FIG. 5 is a configuration diagram of a node according to the embodiments.

The node 301-i includes the system board 311-i, the HDD cage 331-i and the display device 351-i.

The system board 311-i includes a CPU 312-i, a memory 313-i, a chip set 314-i, a BMC 315-i, a RAID controller 316-i, and NVRAMs 317-i and 318-i.

The CPU 312-i is a central processing unit (processor) that controls the entirety of the node 301-i.

The memory 313-i temporarily stores a program stored in the HDD 701 (OS or application program) or data. The memory 313-i is for example a Random Access Memory (RAM). The CPU 2 uses the memory 3 so as to execute a program. Also, the CPU 312-i reads the BIOS stored in the NVRM 317-i so as to execute it.

The chip set 314-i is an integrated circuit including a plurality of integrated circuits that execute various functions. The chip set 314-i manages transmission and reception of data between the CPU 312-i, the BMC 315-i, the display device 315-i and the NVRM 317-i. Also, the chip set 314-i includes a graphic controller, and controls the display of the display device 351-i.

The BMC 315-i monitors hardware such as the CPU 312-i, the memory 313-i, etc. and the temperature, and performs remote control, and stores records of hardware events etc. in the NVRAM 318-i. Also, the BMC 315-i stores the setting value of the BMC 315-i in the NVRAM 318-i. BMC 315-i stores the setting value of the BMC 315-i and the setting value of the BIOS in the NVRAM 501. When the system board 311-i has been replaced, the BMC 315-i of the system 311-i that has been newly attached reads the setting value and the BIOS of the BMC 315-i from the NVRM 501, and restores the state of the system board 311-i before the replacement. The BMC 315-i obtains information related to the HDD 701 such as the implementation position of an HDD unit 601 (HDD 701) and the configuration of the RAID, etc. from the RAID controller 316-i connected by the Inter-Integrated Circuit (i2c). The BMC 315-i records the obtained information related to the HDD 701 in the HDD configuration table 502.

The BMC 315-i stores firmware, reads the firmware and executes it, and thereby performs various processes.

The RAID controller 316-i manages the HDD 701 and data in RAID that operate a plurality of HDDs as one HDD. The RAID controller 316-i is connected to the HDD 701 via Serial Attached SCSI (SAS) or Serial ATA (SATA).

The NVRAM 317-i stores a BIOS. Also, the NVRAM 317-i stores the setting value of the BIOS.

The NVRAM 318-i stores records of hardware events etc. and the setting value of the BMC 315-i.

The HDD cage 331-i stores the HDD unit 601 including the HDD 701. To the HDD cage 331-i, a plurality of HDD units 601, i.e., a plurality of HDDs 701 can be attached. Note that the HDD cage 331-i and the HDD unit 601 will be described later in detail.

The display device 351-i displays inquiries to the user or the maintenance personnel, the state of the node 301-i or results of various processes. The display device 351-i is for example a Liquid Crystal Display (LCD).

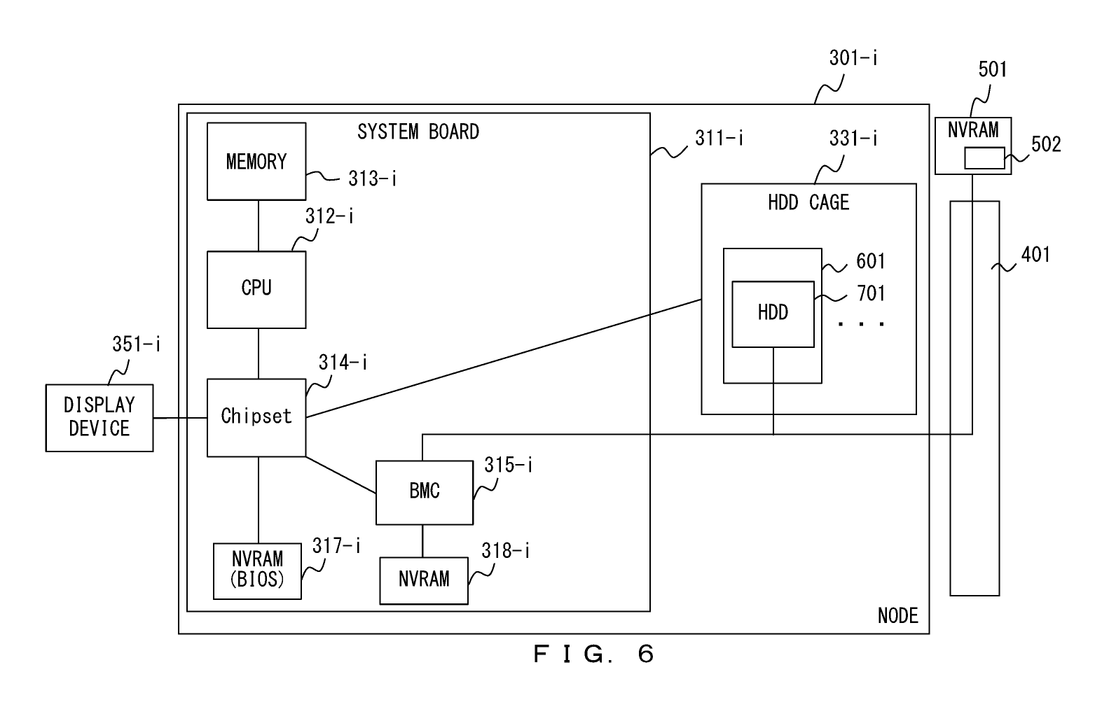

FIG. 6 is another configuration diagram of a node according to the embodiments.

When RAID is not used, the node 301-i may have the configuration illustrated in FIG. 6.

The node 301-i has the system board 311-i, the HDD cage 331-i and the display device 351-i.

The system board 311-i includes the CPU 312-i, the memory 313-i, the chip set 314-i, the BMC 315-i, and the NVRAMs 317-i and 318-i.

The CPU 312-i, the memory 313-i, the chip set 314-i and the NVRAMs 317-i and 318-i of FIG. 6 has similar functions and configurations to the CPU 312-i, the memory 313-i, the chip set 314-i and the NVRAMs 317-i and 318-i of FIG. 5, and thus, the explanations will be omitted.

The chip set 314-i is an integrated circuit including a plurality of integrated circuits that execute various functions. The chip set 314-i manages transmission and reception of data between the CPU 312-i, the BMC 315-i, the display device 315-i, the NVRM 317-i and the HDD 701. Also, the chip set 314-i includes a graphic controller, and controls the display of the display device 351-i. The chip set 314-i includes an HDD controller, and controls reading and writing of the HDD 701. The chip set 314-i is connected to the HDD 701 via Serial ATA (SATA).

The BMC 315-i monitors hardware such as the CPU 312-i, the memory 313-i, etc. and the temperature, performs remote control, and stores records of hardware events etc. in the NVRAM 318-i. Also, the BMC 315-i stores the setting value of the BMC 315-i in the NVRAM 318-i. The BMC 315-i stores the setting value of the BMC 315-i and the setting value of the BIOS in the NVRAM 501. When the system board 311-i has been replaced, the BMC 315-i of the system 311-i that has been newly attached reads the setting value and the BIOS of the BMC 315-i from the NVRM 501, and restores the state of the system board 311-i before the replacement. The BMC 315-i obtains information related to the HDD 701 such as the implementation position of the HDD unit 601 (HDD 701) and the configuration of the RAID, etc. from the HDD back plane to which the HDD unit 601 in the HDD cage 331-i connected via i2c is connected. The BMC 315-i records the obtained information related to the HDD 701 in the HDD configuration table 502.

The HDD cage 331-i and the display device 351-i of FIG. 6 have similar functions and configurations to those of the HDD cage 331-i and the display device 351-i of FIG. 5, and thus, the explanations will be omitted.

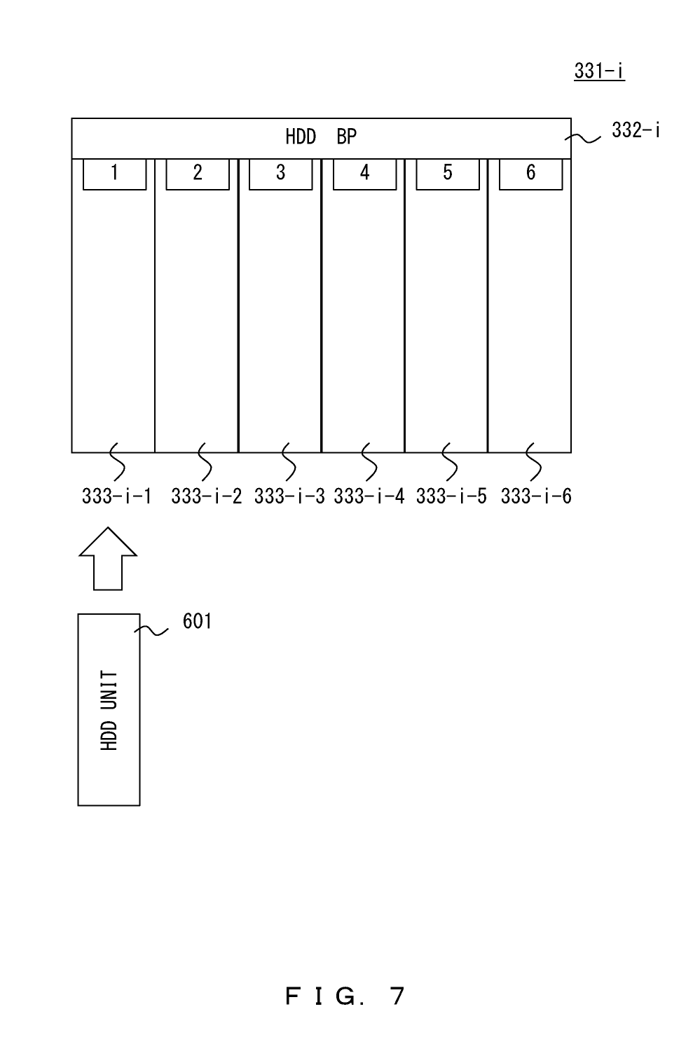

FIG. 7 is a configuration diagram of an HDD cage according to the embodiments.

The HDD cage 331-i includes an HDD back plane (BP) 332-i and a slot 333-i-j (j=1 through 6). To the HDD cage 331-i, an HDD cage number representing the HDD cage 331-i is assigned. To the HDD cages 331-1 through 331-4, HDD cage numbers 1 through 4 are assigned, respectively. In other words, node number i of the node 301-i and the HDD cage number i of the HDD cage 331-i included in the node 301-i have the same number.

The HDD BP 332-i is a board including a connector that connects to the HDD 701 included in the HDD unit 601.

The slot 333-i-j is a frame accommodating the HDD unit 601. To the slots 333-i-j, HDD slot numbers representing the slots 333-i-j are assigned respectively. To the slots 333-i-1 through 333-i-6, HDD slot numbers 1 through 6 are assigned respectively.

When the HDD unit 601 is inserted into the slot 333-i-j, and the HDD 701 included in the HDD unit 601 is connected to the HDD BP 332-i, the system board 311-i is connected and it becomes possible to read and write data from the HDD 701 by the system board 311-i. A fact that the HDD unit 601 has been inserted into the slot 333-i-j may be referred to as that the HDD unit 601 has been attached (implemented) or the HDD 701 has been attached (implemented).

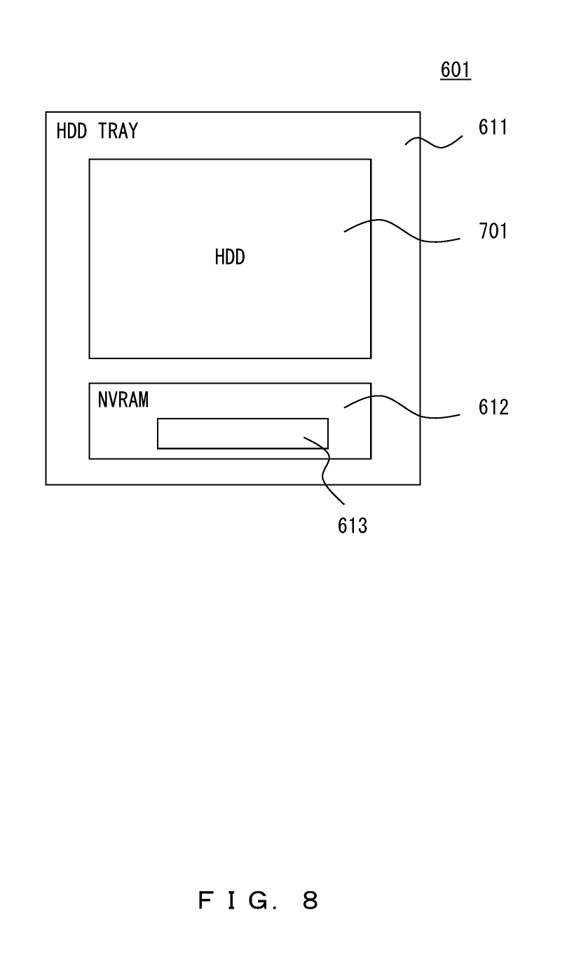

FIG. 8 is a configuration diagram of an HDD unit according to the embodiments.

The HDD unit 601 includes an HDD tray 611 and the HDD 701.

The HDD tray 611 is a container that accommodates the HDD 701. The HDD tray 611 includes an NVRAM 612. The HDD unit 601 is an example of a storage device container.

The NVRAM 612 stores data. The NVRAM 612 stores an HDD position table 613 that represents a position at which the HDD unit 601 is to be attached. The HDD position table 613 will be described later in detail.

The HDD 701 is a storage device that stores programs, data, etc. The HDD 701 is an example of a storage device.

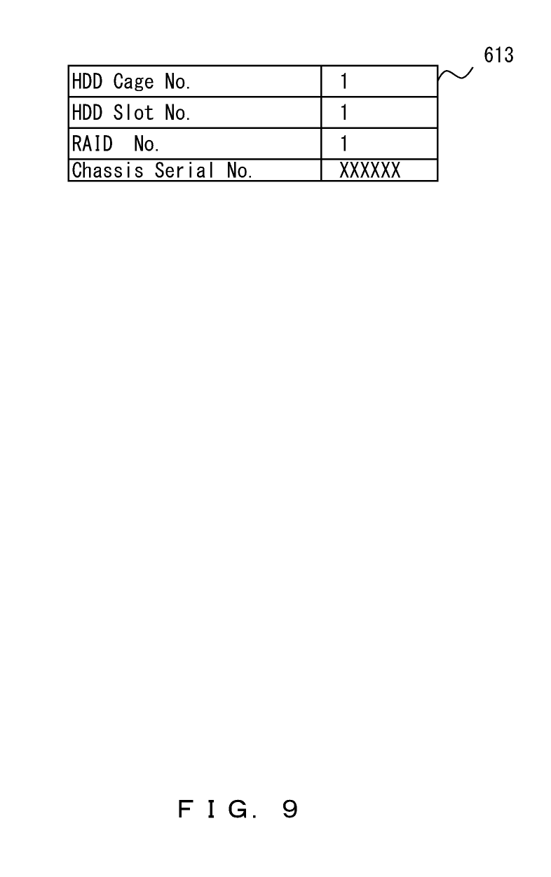

FIG. 9 illustrates an example of an HDD position table.

The HDD position table 613 includes, as items, HDD cage number (HDD Cage No.), HDD slot number (HDD Slot No.), RAID number (RAID No.) and Chassis serial number (Chassis Serial No.). In the HDD position table 613, an HDD cage number, an HDD slot number, a RAID number and a Chassis serial number are described in an associated manner.

An HDD cage number is a number representing the HDD cage 333-i to which the HDD 701 is to be attached. An HDD cage number corresponds to node number i of the node 301-i including the HDD cage 333-i. In other words, the HDD cage numbers of the HDD cages 333-1 through 333-4 are 1 through 4, respectively.

An HDD slot number is a number representing the slot 333-i-j to which the HDD 701 is to be attached. The HDD slot number=j represents the slot 333-i-j.

A RAID number is a number representing a RAID group constituted by the HDD 701 of the HDD unit 601.

A Chassis serial number is a number assigned to the Chassis 201 for identifying the Chassis 201.

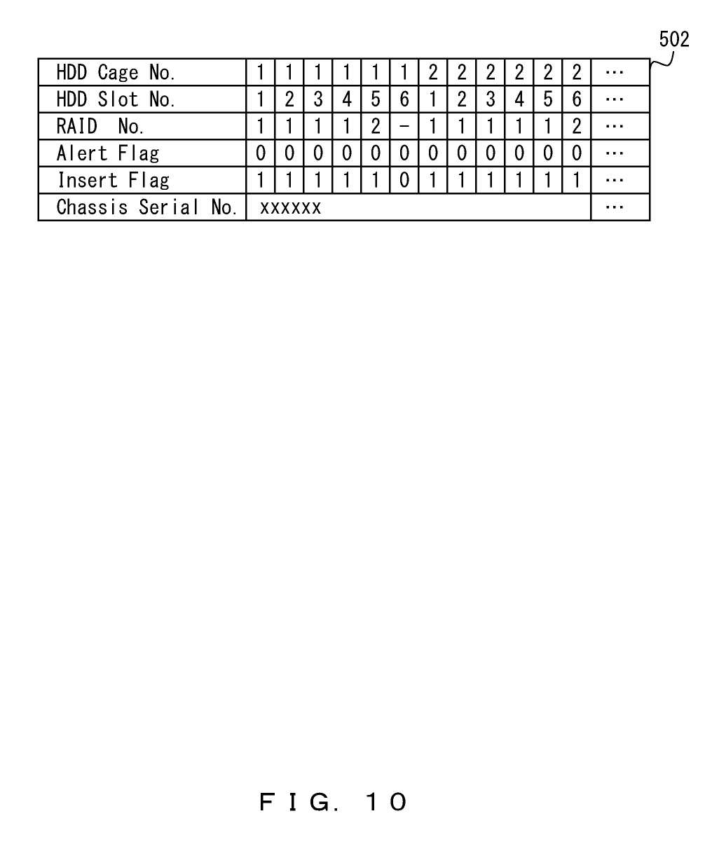

FIG. 10 illustrates an example of an HDD configuration table.

The HDD configuration table 502 includes, as items, HDD cage number (HDD Cage No.), HDD slot number (HDD Slot No.), RAID number (RAID No.), alert flag, insert flag and Chassis serial number (Chassis Serial No.). In the HDD configuration table 502, an HDD cage number, an HDD slot number, a RAID number, an alert flag, an insert flag and a Chassis serial number are described in an associated manner.

An HDD cage number is a number representing the HDD cage 333-i. An HDD cage number corresponds to node number i of the node 301-i including the HDD cage 333-i. In other words, the HDD cage numbers of the HDD cages 333-1 through 333-4 are 1 through 4, respectively.

An HDD slot number is a number representing the slot 333-i-j to which the HDD 701 is to be attached. The HDD slot number j represents the slot 333-i-j.

An RAID number is a number representing an RAID group constituted by the HDD 701 of the HDD unit 601 attached to the slot 333-i-j that corresponds to the HDD cage number and the HDD slot number.

An alert flag represents presence or absence of errors such as erroneous implementation, insertion omission, etc. Alert flag=0 represents that it is normal. In other words, it is represented that the HDD cage number and the HDD slot number of the HDD position table 613 of the HDD unit 601 and the HDD slot number representing the HDD cage 333-i to which the HDD 701 of the HDD unit 601 has been attached and the slot 333-i-j match respectively. Alert flag=1 represents an error, representing that there exists erroneous implementation, insertion omission, etc. of the HDD unit 601.

An insert flag represents that the HDD 701 is to have been attached to the slot 333-i-j corresponding to the HDD cage number and the HDD slot number. When the insert flag=1, it is represented that the slot is the slot 333-i-j to which the HDD 701 is to have been attached. When the insert flag=0, it is represented that the slot is the slot 333-i-j to which the HDD 701 does not have to attached.

A Chassis serial number is a number assigned to the Chassis 201 for identifying the Chassis 201,

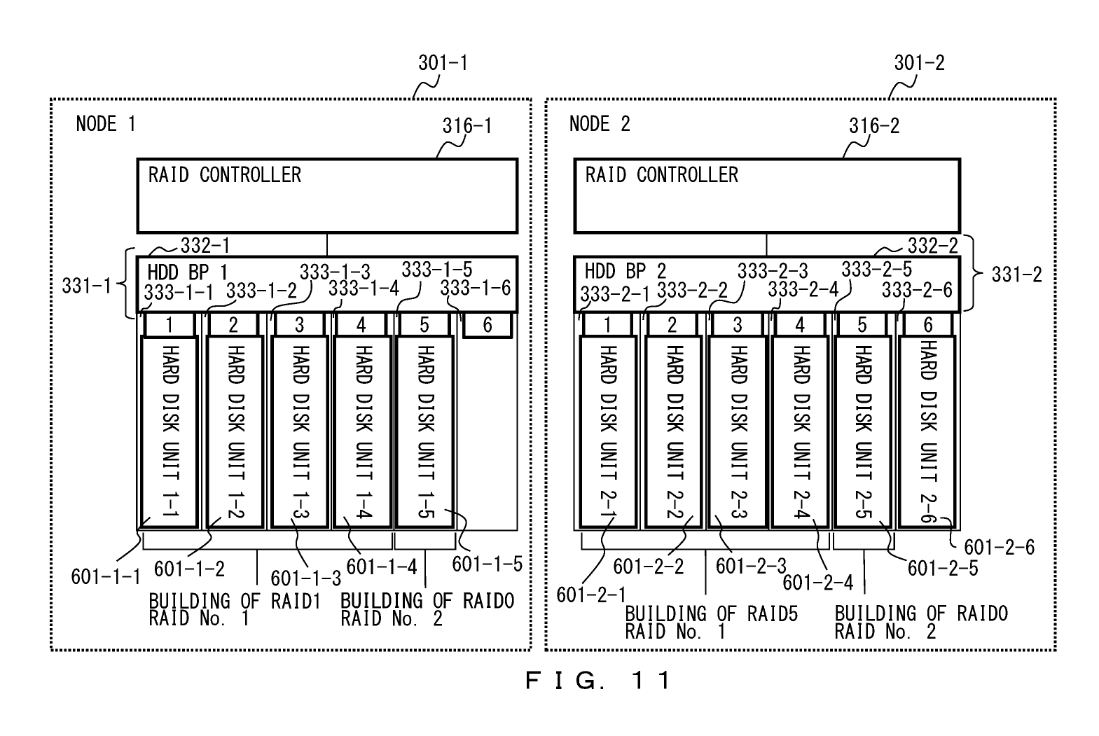

FIG. 11 illustrates a configuration example of an HDD.

To the slot 333-1-1 through slot 333-1-5 (HDD slot number=1 through 5) of the HDD cage 331-1 (HDD cage number=1) of the node 301-1, the HDD units 601-1-1 through 601-1-5 have been attached respectively. Into the slot 333-1-6, an HDD unit has not been inserted.

The HDD units 601-1-1 through 601-1-4 constitute RAID1, constituting one RAID group (RAID number=1). Also, the HDD unit 601-1-5 constitutes RAID0, constituting one RAID group (RAID number=2).

To the slot 333-2-1 through slot 333-2-6 (HDD slot number=1 through 6) of the HDD cage 331-2 (HDD cage number=2) of the node 301-2, the HDD units 601-2-1 through 601-2-6 have been attached respectively.

The HDD units 601-2-1 through 601-2-5 constitute RAID5, constituting one RAID group (RAID number=1). Also, the HDD unit 601-2-6 constitutes RAID0, constituting one RAID group (RAID number=2).

FIG. 10 illustrates the HDD configuration table 502 corresponding to configuration of the HDD unit 601 illustrated in FIG. 11.

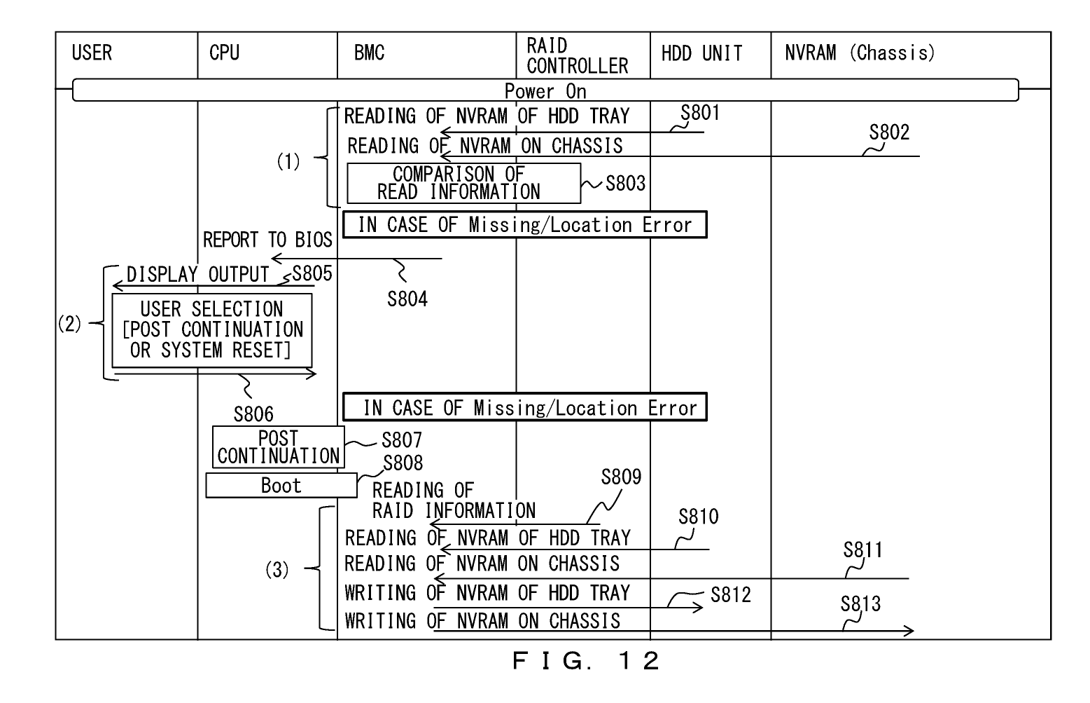

FIG. 12 illustrates a sequence diagram of a process of a node according to the embodiments.

In this example, explanations will be give for a process performed by the node 303-1. Note that the explanations will also apply to the process of the nodes 301-2 through 301-4. The server 101 including a plurality of nodes 301-i turns on the nodes 301-1, 301-2, 301-3 and 301-4 in this order, and the node 301-i that has been turned on performs the following process.

First, the node 301-1 is turned on by the user, and the CPU 312-1 executes the BIOS.

The node 301-1 performs a process including (1) comparison phase, (2) error process phase and (3) writing phase.

(1) Comparison Phase

The BMC 315-1 reads the HDD position table 613 from the NVRAM 612 (step S801) and reads the HDD configuration table 502 from the NVRAM 501 (step S802).

The BMC 315-1 compares the HDD position table 613 and the HDD configuration table 502 so as to determine whether or not there exists an error such as erroneous implementation or insertion omission.

When it is determined that there exists erroneous implementation or insertion omission of the HDD unit 601, the BMC 315-1 reports an error to the CPU 312-1 (step S804).

(2) Error Process Phase

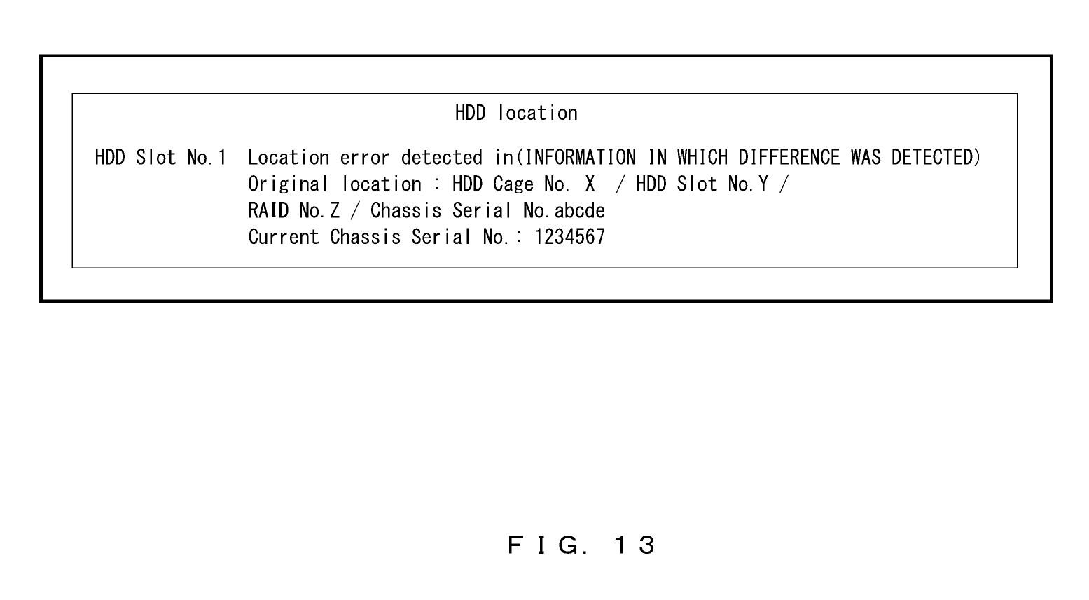

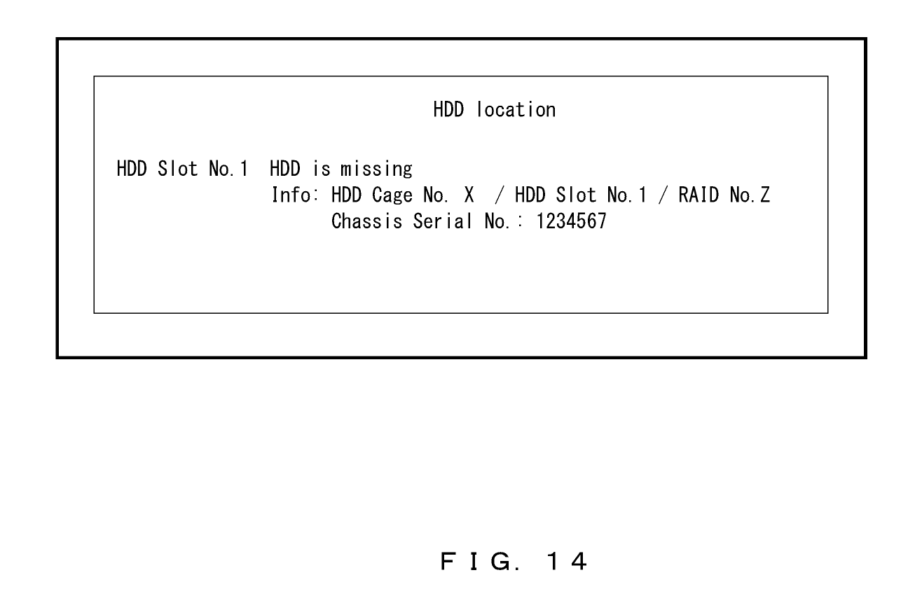

The CPU 312-1 receives the report of the error and displays the contents of the error in the display device 351-1 (step S805). When there exists erroneous implementation of the HDD unit 601, the CPU 312-1 displays a window as illustrated in FIG. 13 in the display device 351-1. In case of erroneous implementation, the CPU 312-1 displays information (HDD cage number and HDD slot number) representing the slot 333-i-j to which the wrong HDD unit 601 has been attached and information (HDD cage number and HDD slot number) representing the right slot 333-i-j to which the HDD unit 601 is to be attached. When there exists insertion omission of the HDD unit 601, the CPU 312-1 displays a window as illustrated in FIG. 14 in the display device 351-1. In case of insertion omission, the CPU 312-1 displays information (HDD cage number and HDD slot number) representing the slot 333-i-j to which the HDD unit 601 that is to be attached has not been inserted.

The CPU 312-1 waits for an input from the user. The user inputs an instruction to continue Power On Self Test (POST) or an instruction to reset the node 301-1 (step S806). When detecting an instruction input from the user, the CPU 312-1 performs a process in accordance with the input instruction.

When an error such as erroneous implementation or insertion omission was not detected in step S803 or when an instruction to continue POST was input in step S806, the CPU 312-1 continues POST, and performs boot (step S808).

(3) Writing Phase

The BMC 315-1 obtains information of RAID from the RAID controller 316 (step S809), reads the HDD position table 613 from the NVRAM 612 (step S810), and reads the HDD configuration table 502 from the NVRAM 501 (step S811). The BMC 315-1 writes the current state of the HDD 701 to the HDD position table 613 (step S812), and writes the current state of the HDD 701 to the HDD configuration table 502 (step S813).

Brief explanations have been given for the processes performed by the node 301-1 by using the sequence diagrams above, and detailed explanations will further be given for processes performed by the node 301-1. Note that the explanations will also apply to the process of the nodes 301-2 through 301-4.

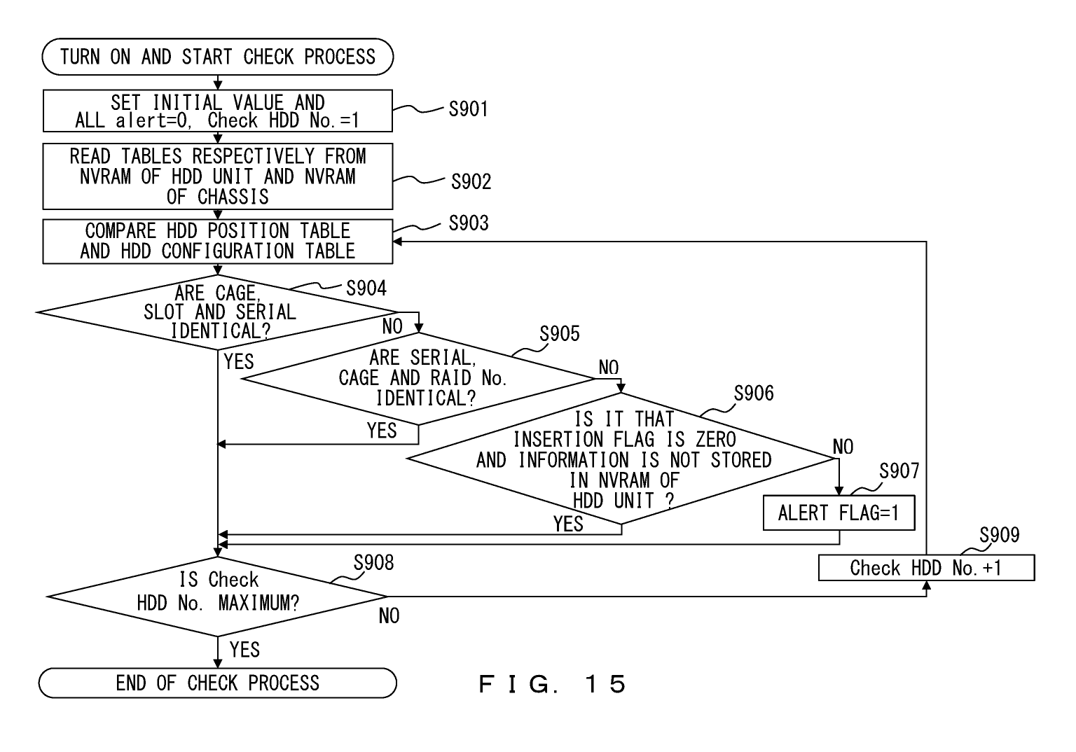

FIG. 15 is a flowchart of a check process according to the embodiments.

In step S901, the BMC 315-1 sets the alert flag of the record with HDD cage number=1 to zero in the HDD configuration table 502. The BMC 315-1 sets the check HDD number to 1. A check HDD number is a number representing the slot 333-i-j as a check target and the HDD unit 601 and the HDD 701 attached to the slot 333-1-j. The check HDD numbers corresponding to the slot 333-1-1 through slot 333-1-6 (the HDD units 601 and the HDDs 701 attached to the slot 333-1-1 through slot 333-1-6) are 1 through 6, respectively. Also, the HDD 701 corresponding to the check HDD number will be referred to as a check target HDD.

In step S902, the BMC 315-1 reads the HDD position table 613 from each of the NVRAMs 612 of all the HDD units 601 in the HDD cage 331-1, and reads the record with HDD cage number=1 in the HDD configuration table 502 from NVRAM 501.

In step S903, the BMC 315-1 compares the HDD position table 613-j read from the HDD unit 601-j stored in the slot 333-1-j that corresponds to the check HDD number and the information of the record corresponding to the HDD cage number=1 and HDD slot number=check HDD number.

In step S904, the BMC 315-1 determines whether or not the HDD cage number, the HDD slot number and the Chassis serial number are identical in the comparison in step S903. When the HDD cage number, the HDD slot number and the Chassis serial number are identical, the control proceeds to step S908, and when the HDD cage number, the HDD slot number and the Chassis serial number are not identical, the control proceeds to step S905.

In step S905, the BMC 315-1 determines whether or not the Chassis serial number, the HDD cage number and the RAID number are identical. When the Chassis serial number, the HDD cage number and the RAID number are identical, the control proceeds to step S908, and the Chassis serial number, the HDD cage number and the RAID number are not identical, the control proceeds to step S906.

In step S906, the BMC 315-1 determines whether it is that the insertion flag corresponding to HDD slot number=check HDD number in the HDD configuration table 502 is zero and information (HDD cage number, the HDD slot number, the RAID number and the Chassis serial number) has not been described in the HDD position table 613. When the insertion flag corresponding to HDD slot number=check HDD number in the HDD configuration table 502 is zero and information has not been described in the HDD position table 613, the control proceeds to step S908. When the insertion flag corresponding to HDD slot number=check HDD number in the HDD configuration table 502 is not zero or information has been described in the HDD position table 613, the control proceeds to step S907.

In step S907, the BMC 315-1 writes 1 to the alert flag corresponding to HDD cage number=1 and the HDD slot number=check HDD number in the HDD configuration table 502.

In step S908, the BMC 315-1 determines whether or not the check number is the maximum value. When the check HDD number is the maximum value, the check process is terminated, and when the check HDD number is not the maximum value, the control proceeds to step S907. The maximum value as the check HDD number is the number of the slots 333-1-j, and the maximum value as the check HDD number is 6 in the actual embodiment.

In step S909, the BMC 315-1 increments the check HDD number by 1.

The BMC 315-i starts a display process when the check process is terminated.

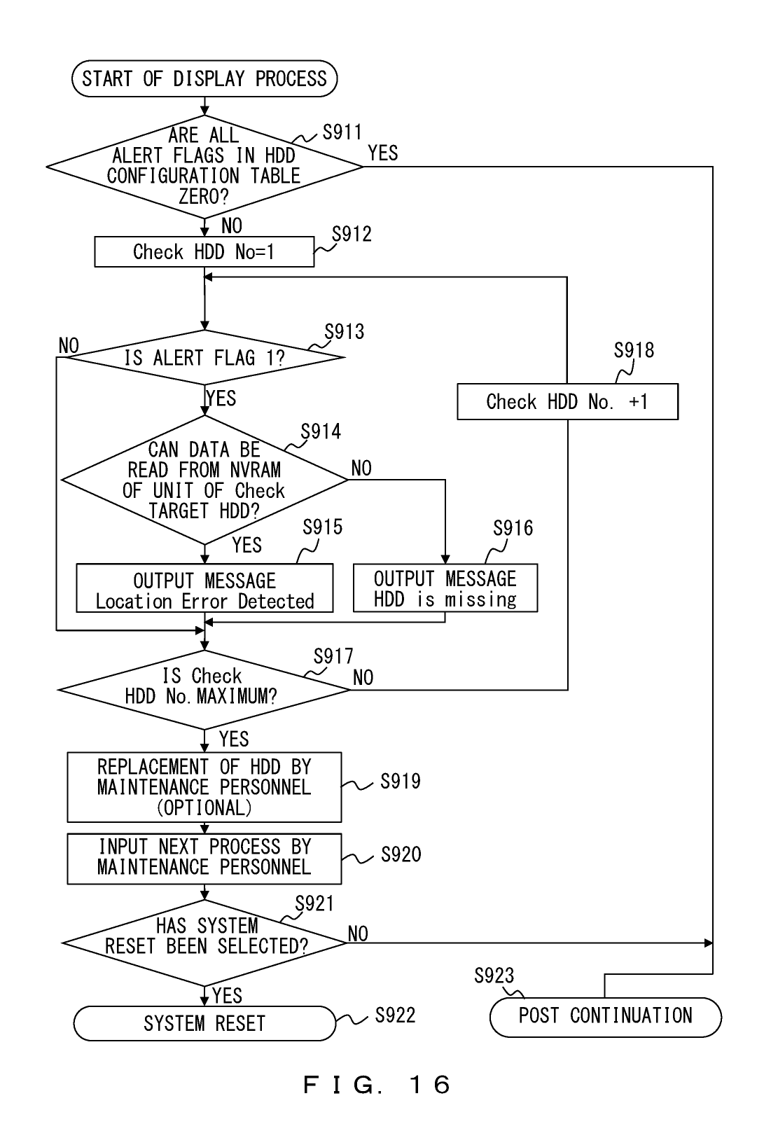

FIG. 16 is a flowchart of a display process according to the embodiments.

In step S911, the BMC 315-1 determines whether or not all the alert flags with HDD cage number=1 in the HDD configuration table 502 are zero. When all the alert flags with the HDD cage number=1 are zero, the control proceeds to step S923, and when not all the alert flags with HDD cage number=1 are zero, the control proceeds to step S912.

In step S912, the BMC 315-1 sets the check target HDD number to 1.

In step S913, the BMC 315-1 determines whether or not the alert flag corresponding to HDD slot number=check target HDD number is 1 in the HDD configuration table 502. When the alert flag is 1, the control proceeds to step S914, and when the alert flag is not 1, the control proceeds to step S916.

In step S914, the BMC 315-1 determines whether or not the HDD position table 613 can be read from the NVRAM 612 of the HDD unit 601-j including a check target HDD. When the HDD position table 613 can be read, the control proceeds to step S915, and when it is not possible to read the HDD position table 613, the control proceeds to step S916. When the HDD unit 601-j has not been attached and it is not possible to read the HDD position table 613 or when the information of the HDD position table 613 has not been written (blank), it is determined that it is not possible to read the HDD position table 613.

In step S915, the BMC 315-1 outputs, to the CPU 312-1, the fact that there exists erroneous implementation of an HDD, the record corresponding to HDD cage number=1 and HDD slot number=check HDD number in the HDD configuration table 502, and the HDD position table 613 read from the HDD unit 601 attached to the slot 333-1-j corresponding to the check HDD number. The CPU 312-1 displays, in the display device 351-1, the fact that there exists erroneous implementation of an HDD, the information representing the slot into which the erroneously-implemented HDD has been attached, and the right slot into which the erroneously-implemented HDD is to be attached. Information representing a slot into which an erroneously-implemented HDD has been attached is an HDD slot number representing the slot 333-1-j that corresponds to the check HDD number. Information representing a right slot into which an erroneously-implemented HDD is to be attached is the HDD cage number, the HDD slot number and the chassis serial number of the HDD table 613 of the HDD unit 601 that has been attached to the slot 333-1-j corresponding to the check HDD number. Also, the CPU 312-1 displays, in the display device 351-1, the RAID number of the HDD position table 613 of the HDD unit attached to the slot 333-1-j that corresponds to the check HDD number and the chassis serial number of the HDD configuration table 502.

In step S916, the BMC 315-1 outputs, to the CPU 312-1, the fact that there exists insertion omission of an HDD and the record corresponding to HDD cage number=1 and HDD slot number=check HDD number in the HDD configuration table 502. The CPU 312-1 displays, in the display device 351-1, the fact that there exists insertion omission of an HDD and information representing the slot to which the HDD that is to be attached has not been inserted. Information representing a slot into which an HDD that is to be attached has not been inserted is the HDD cage number and the HDD slot number that represent the slot 333-1-j corresponding to the check HDD number. Also, the CPU 312-1 displays, in the display device 351-1, the RAID number and the chassis serial number corresponding to HDD cage number=1 and HDD slot number=check HDD number in the HDD configuration table 502.

In step S917, the BMC 315-1 determines whether or not the check HDD number is the maximum value. When the check HDD number is the maximum value, the control proceeds to step S919, and when the check HDD number is not the maximum value, the control proceeds to step S918.

In step S918, the BMC 315-1 increments the check HDD number by 1.

In step S919, the maintenance personnel replaces the HDD unit 601 when it is needed.

In step S920, the maintenance personnel inputs an instruction.

In step S921, the CPU 312-1 detects an input instruction, and when an instruction to reset the system has been input, the control proceeds to step S922, and when an instruction to reset the system has not been input (when an instruction to continue POST is input), the control proceeds to step S923.

In step S922, the CPU 312-1 resets the node 301-1.

In step S923, the CPU 312-1 continues POST.

Post is continued and the BMC 315-1 performs an update process after the boot.

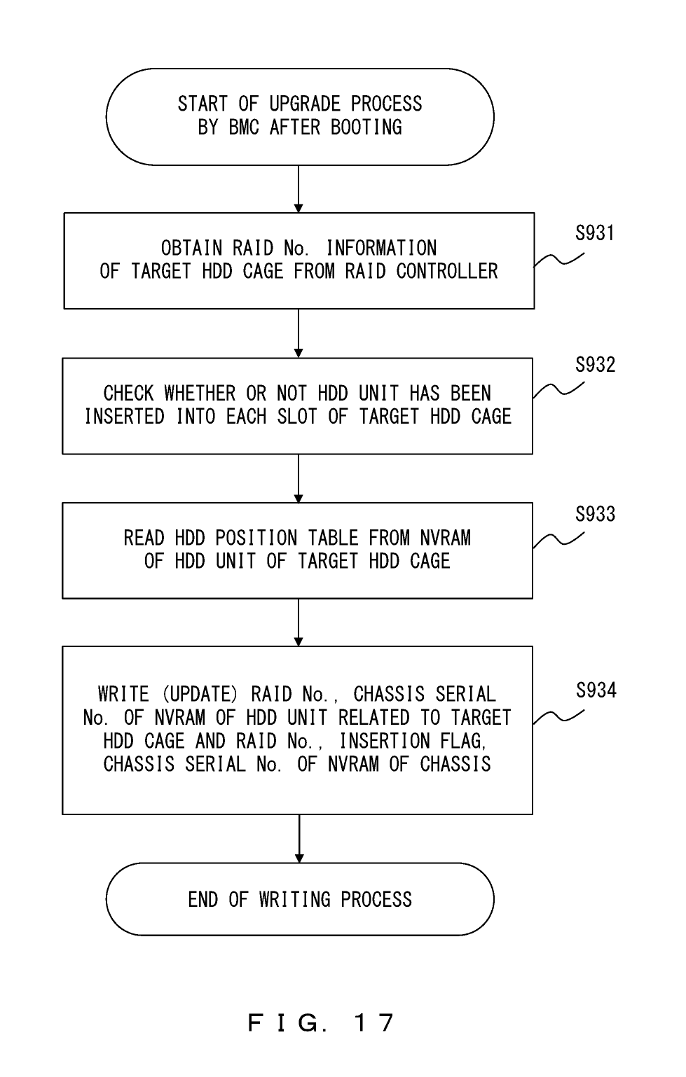

FIG. 17 is a flowchart of an update process according to the embodiments.

In step S931, the BMC 315-1 obtains a RAID number assigned to the HDD 701 that has been attached to the slot 333-i-j in the HDD cage 331-1 from the RAID controller 316.

In step S932, the BMC 315-1 checks whether or not the HDD unit 601 (i.e., the HDD 701) has been attached to each slot 333-1-j in the HDD cage 331-1.

In step S933, the BMC 315-1 reads the HDD position table 613 of each HDD unit 601 in the HDD cage 331-1.

In step S934, the BMC 315-1 writes the RAID number assigned to the HDD 701 of the HDD unit 601 including the HDD position table 613 and the serial number of the chassis 201 respectively to the RAID number and the chassis serial number of the HDD position table 613 of each HDD unit 601 in the HDD cage 331-1. Also, when an HDD cage number is not described in the HDD position table 613, the BMC 315-1 writes, as the HDD cage number of the HDD position table 613, the HDD cage number corresponding to the HDD cage 331-1 that stores the HDD unit 601 including the NVRAM 612 in which that HDD position table 613 is stored. When an HDD slot number is not described in the HDD position table 613, the BMC 315-1 writes, as the HDD slot number of the HDD position table 613, the HDD slot number corresponding to the slot 333-1-j to which the HDD unit 601 including the NVRAM 612 in which that HDD position table 613 is stored has been attached.

Also, the BMC 315-1 writes the RAID number assigned to that HDD 701 that has been attached to the slot 333-1-j corresponding to the target HDD cage number and that the target HDD slot number to the RAID number corresponding to the target HDD cage number and the target HDD slot number of the HDD configuration table 502. The BMC 315-1 writes a value (1 or zero) on the basis of the check result in step S932 to an insertion flag that corresponds to the target HDD cage number and the target HDD slot number of the HDD configuration table 502. Also, the BMC 315-1 writes the serial number of the chassis 201 to the chassis serial number corresponding to the target HDD cage number and the target HDD slot number of the HDD configuration table 502. Note that a target HDD number and a target HDD slot number of the BMC 315-1 are the HDD cage number (=1) of the HDD cage 333-1 included in the node 301-1 that includes the BMC 315-1 and the HDD slot numbers (=1 through 6) of the slot 333-1-j included in the HDD 333-1. In other words, the BMC 315-1 writes the RAID number, the insertion flag and the chassis serial number corresponding to each of the HDD cage number=1 and HDD slot number=1 through 6 in the HDD configuration table 502. Note that the BMC 315-1 writes a target HDD cage number and a target HDD slot number when the target HDD cage number and the HDD slot number are have not been written in the HDD configuration table 502.

Next, explanations will be given for an example in which erroneous implementation (Location Error) of a case of a wrong attachment position of the HDD unit 601 is detected.

In this example, it is assumed that the server 101 is using the nodes 301-1 and 301-2 and is not using the node 301-3 or 301-4.

To the slot 333-1-1 through slot 333-1-6 of the HDD cage 331-1 of the node 301-1, the HDD unit 601-1-1 through HDD unit 601-1-6 (which will be referred to as the HDD unit 1-1 through HDD unit 1-6 hereinafter) have been attached. The node 301-1 includes a RAID controller 316-1, and has built RAID5 by using the HDD units 1-1 through 1-6.

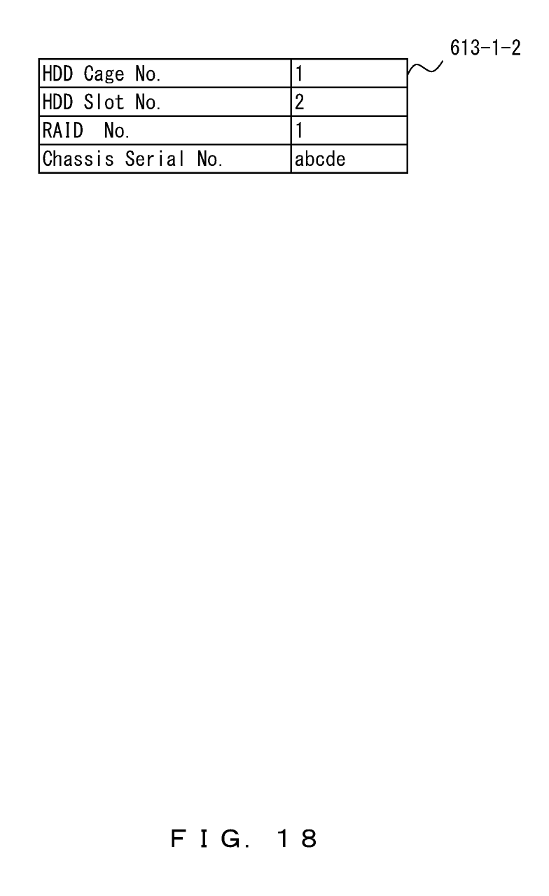

FIG. 18 illustrates the HDD position table 613-1-2 included in the HDD unit 1-2. The HDD cage number of the HDD position table 613-1-2 is 1, the HDD slot number is 2, the RAID number is 1 and the chassis serial number is abcde.

To the slot 333-2-1 through slot 333-2-6 of the HDD cage 331-2 of the node 301-2, the HDD units 601-2-1 through 601-2-6 (which will be referred to as HDD units 2-1 through 2-6 hereinafter) have been attached. Note that RAID has not been built in the node 301-2. Also, an OS is stored in an HDD of the HDD unit 2-4.

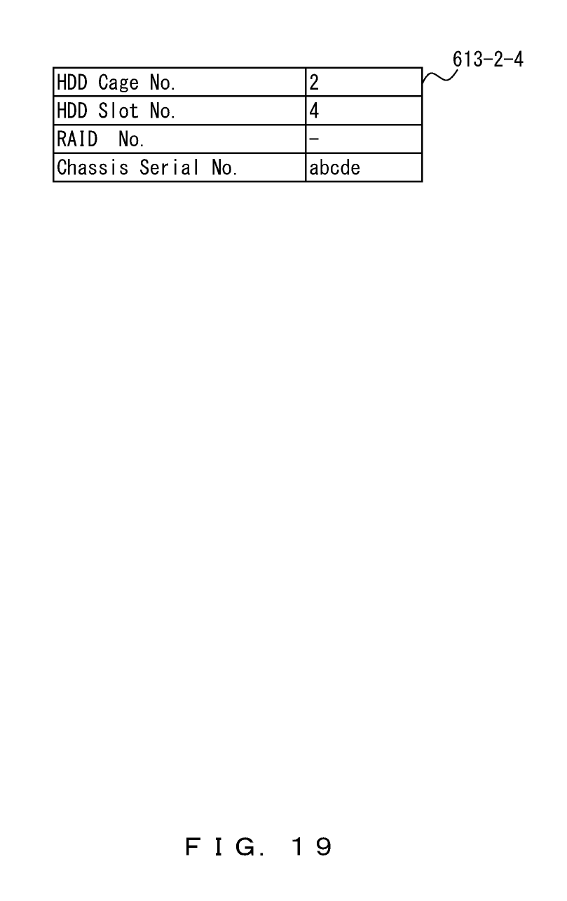

FIG. 19 illustrates the HDD position table 613-2-4 included in the HDD unit 2-4. The HDD cage number of the HDD position table 613-2-4 is 2, the HDD slot number is 4, the RAID number is blank (-) and the chassis serial number is abcde.

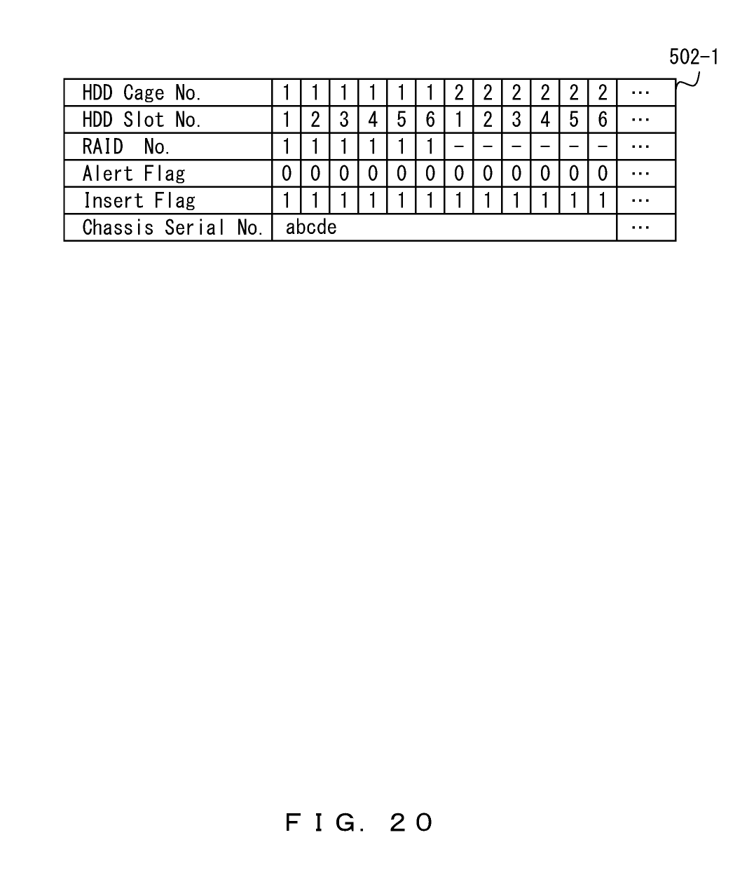

FIG. 20 illustrates the HDD configuration table 502-1 during the operation (before maintenance) of the server 101. All the alert flags in the HDD configuration table 502-1 are zero, and all the HDD units 601 have been attached to the right positions.

The server 101 generates the above HDD position tables 613-1-2, 613-2-4 and the HDD configuration table 502-1 through the above check process, display process and update process.

In this example, it is assumed that the maintenance personnel removed the HDD units 1-1 through 1-6 and 2-1 through 2-6 for the maintenance of the server 101 and again attached the HDD units 1-1 through 1-6 and 2-1 through 2-6 after the maintenance. Then, it is assumed that the HDD units 1-2 and 2-4 have been attached contrarily, i.e., that the HDD unit 1-2 has been attached to slot 333-2-4 and the HDD unit 2-4 has been attached to the slot 333-1-2.

After turning on the node 301-1, the BMC 315-1 starts a check process, reads the HDD position tables 613-1-1, 613-2-4 and 613-1-3 through 613-1-6 from the HDD units 1-1, 2-4 and 1-3 through 1-6 respectively attached to the slot 333-1-1 through slot 333-1-6, and reads the record with HDD cage number=1 from the HDD configuration table 502-1, and compares the HDD position tables 613-1-1, 613-2-4 and 613-1-3 through 613-1-6 with the record with HDD cage number=1 of the HDD configuration table 502-1. Differences of the HDD cage number and the HDD slot number are detected in comparison between the HDD position table 613-2-4 and the record with HDD cage number=1 and HDD slot number=2 in the HDD configuration table 502-1. The BMC 315-1 describes “1” in the alert flag corresponding to HDD cage number=1 and HDD slot number=2 that represent the slot 333-1-2 to which the HDD unit 2-4 has been attached in the HDD configuration table 502-1, the HDD unit 2-4 being an HDD unit for which erroneous implementation was detected.

Similarly, after turning on the node 301-2, the BMC 315-2 starts the check process of FIG. 15, reads the HDD position tables 613-2-1 through 613-2-3, 613-1-2 and 613-2-5 through 613-2-6 from the HDD units 2-1 through 2-3, 1-2 and 2-5 through 2-6 respectively attached to the slot 333-2-1 through slot 333-2-6, and reads the record with HDD cage number=2 in the HDD configuration table 502-1 from the NVRAM 501, and compares the HDD position tables 613-2-1 through 613-2-3, 613-1-2 and 613-2-5 through 613-2-6 with the record with HDD cage number=2 in the HDD configuration table 502-1. Differences of the HDD cage number and the HDD slot number are detected in comparison between the HDD position table 613-1-2 and the record with HDD cage number=2 and HDD slot number=4 in the HDD configuration table 502-1. The BMC 315-2 describes “1” in the alert flag corresponding to HDD cage number=2 and HDD slot number=4 that represent the slot 333-2-4 to which the HDD unit 1-2 has been attached in the HDD configuration table 502-1, the HDD unit 1-2 being an HDD unit for which erroneous implementation was detected.

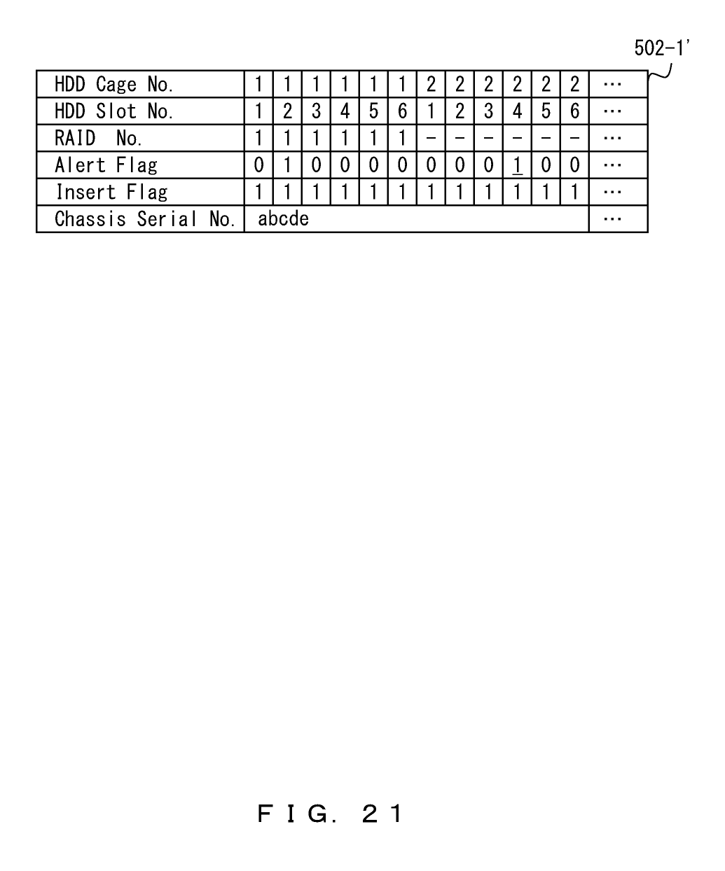

Thereby, the HDD configuration table 502-1 becomes an HDD configuration table 502-1′ as illustrated in FIG. 21.

After the termination of the check process, the BMC 315-1 starts the display process as illustrated in FIG. 16, detects HDD slot number=2 corresponding to alert flag=1 from among records with HDD cage number=1 in the HDD configuration table 502-1′, and detects that there exists an error in the slot 333-1-2. Because it is possible to read the HDD position table 613-2-4 from the HDD unit 2-4 attached to the slot 333-1-2, the BMC 315-1 determines that the type of an error is erroneous implementation. The BMC 315-1 reports, to the CPU 312-1, error information including the type of the error, the slot of erroneous implementation, the HDD cage number and the HDD slot number representing the slot to which the HDD unit 2-4 is to be attached, and the CPU 312-1 displays error information in the display device 351-1.

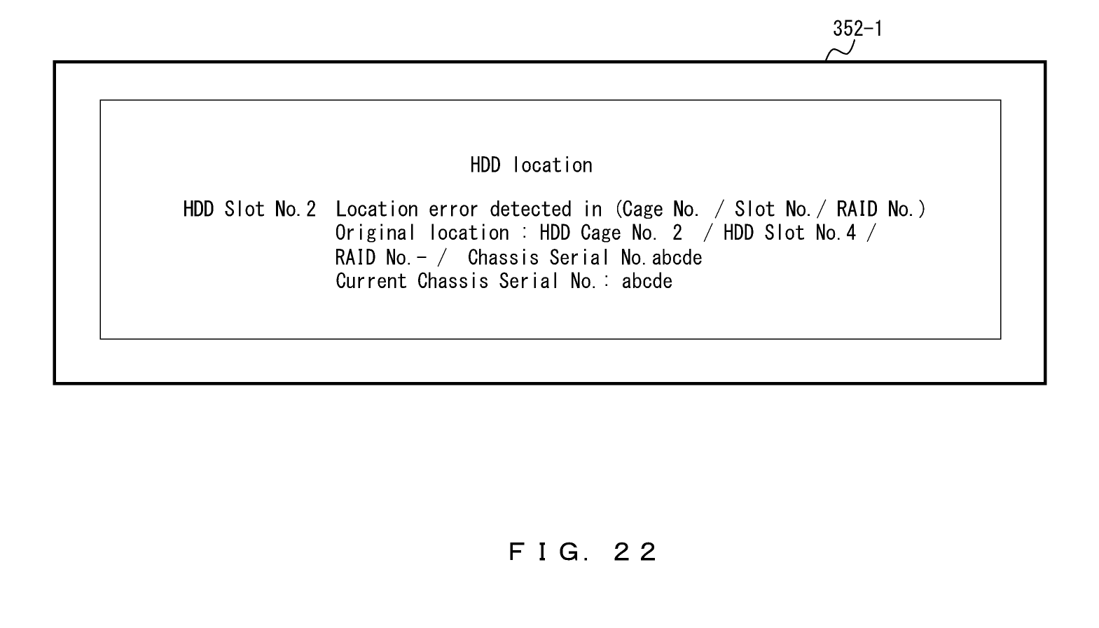

FIG. 22 illustrates a display window in case of detection of erroneous implementation.

In the display window 352-1, “Location Error detected”, which means that erroneous implementation has been detected, is displayed. Also, in the display window 352-1, slot number=2 of the slot 333-1-2 in which the erroneous implementation has been detected and chassis serial number=abcde included in the HDD configuration table 502 are displayed. Also, in the display window 352-1, HDD cage number=2, the HDD slot number=4, RAID number=blank (-) and chassis serial number=abcde read from the HDD unit 2-4 that has been attached to the slot 333-1-2 in which the erroneous implementation was detected are displayed. in other words, in the display window 352-1, information representing the right position for the HDD unit 2-4 attached to the slot 333-1-2 in which the erroneous implementation was detected is displayed.

Similarly, after the termination of the check process, the BMC 315-2 starts the display process as illustrated in FIG. 16 so as to detect HDD slot number=4 corresponding to alert flag=1 from among records with HDD cage number=2 and detects that there exists an error in the slot 333-2-4 in the HDD configuration table 502-1′. Then, the CPU 312-2 displays error information in the display device 351-2.

The maintenance personnel attaches the erroneously-implemented HDD units 1-2 and 2-4 to the right positions and resets the server 102 on the basis of the error information displayed in the display devices 351-1 and 351-2. After resetting, the BMCs 315-1 and 315-2 again perform the check process and the display process so as to confirm that all the alert flags are zero, and thereafter continue POST, and the update process of FIG. 17 is performed.

Next, explanations will be given for an example in which insertion omission (HDD is missing) is detected in case when new HDD unit 601 has been attached to the slot 333-i-j instead of the HDD unit 601 that is to be attached to the slot 333-i-j.

In this example, it is assumed that the server 101 is using the nodes 301-1 and 301-2 and is not using the node 301-3 or 301-4.

To the slot 333-1-1 through slot 333-1-6 of the HDD cage 331-1 of the node 301-1, the HDD unit 601-1-1 through HDD unit 601-1-6 (which will be referred to as the HDD unit 1-1 through HDD unit 1-6 hereinafter) have been attached. The node 301-1 includes the RAID controller 316-1, and has built RAID5 by using the HDD units 1-1 through 1-6.

To the slot 333-2-1 through slot 333-2-6 of the HDD cage 331-2 of the node 301-2, the HDD units 601-2-1 through 601-2-6 (which will be referred to as HDD units 2-1 through 2-6 hereinafter) have been attached. Note that RAID has not been built in the node 301-2.

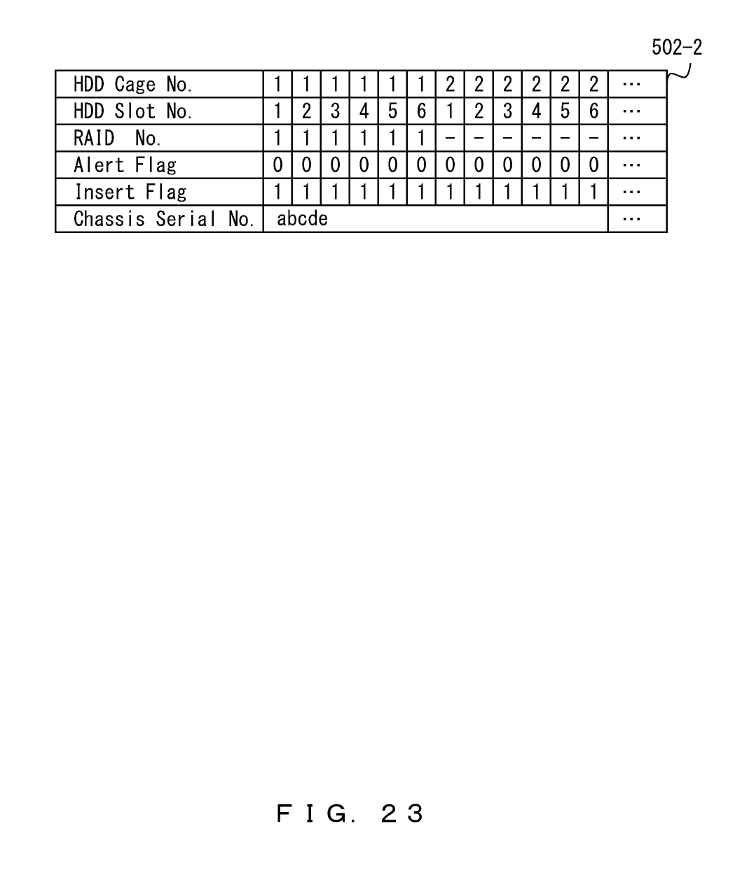

FIG. 23 illustrates an HDD configuration table 502-2 during the operation (before maintenance) of the server 101. All the alert flags in an HDD configuration table 502-4 are zero, and all the HDD units 601 have been attached to the right positions.

The server 101 generates the above HDD configuration table 502-2 by the above check process, display process and update process.

In this example, it is assumed that the maintenance personnel removed the HDD units 1-1 through 1-6 and 2-1 through 2-6 for the maintenance of the server 101, and after the maintenance again attached the HDD units 1-1 through 1-6, 2-1, 2-3 through 2-6 to the same positions as those before the maintenance. It is also assumed that the maintenance personnel erroneously attached the HDD unit 601-a instead of the HDD 1-2 to the slot 333-2-2, the HDD unit 601-a being an HDD unit for which data has not been written in a NVRAM 612-a (i.e., the values of the HDD slot number, the RAID number and the chassis serial number have not been written in an HDD position table 613-a).

After turning on the node 301-1, the BMC 315-1 starts a check process, reads the HDD position tables 613-1-1 through 613-1-6 from the HDD units 1-1 through 1-6 respectively attached to the slot 333-1-1 through slot 333-1-6, reads the record with HDD cage number=1 in the HDD configuration table 502-2 from the NVRAM 501, and compares the read information. In this comparison, differences of the HDD cage number, the HDD slot number and the RAID number are not detected. Accordingly, all the alert flags corresponding to HDD cage number=1 in the HDD configuration table 502-2 are zero, and the node 301-1 continues POST, performs an update process, and writes the HDD position tables 613-1-1 through 613-1-6 and the record with HDD cage number=1 in the HDD configuration table 502-2.

Similarly, after turning on the node 301-2, the BMC 315-2 starts the check process of FIG. 15, reads the HDD position tables 613-2-1, 613-a, and 613-2-3 through 613-2-6 from the HDD units 2-1, 601-a and 2-3 through 2-6 respectively attached to the slot 333-2-1 through slot 333-2-6, and reads the table with HDD cage number=2 in the HDD configuration table 502-1 from the NVRAM 501, and compares the read information. Difference of the HDD cage number and the HDD slot number are detected in the comparison between the HDD position table 601-a and the record with HDD cage number=2 and HDD slot number=2 in the HDD configuration table 502-1, and it is detected that data is not written in the HDD position table 601-a, and it is detected that the insertion flag with HDD cage number=2 and HDD slot number=2 is 1 in the HDD configuration table 502-1. Thereby, it is detected that an HDD unit that is to be attached has not been attached to the slot 333-2-2 and a new HDD unit has been attached, i.e., insertion omission is detected.

The BMC 315-2 describes “1” in the alert flag corresponding to HDD cage number=2 and HDD slot number=2 that represent the slot 333-2-2 in which insertion omission was detected, in the HDD configuration table 502-1.

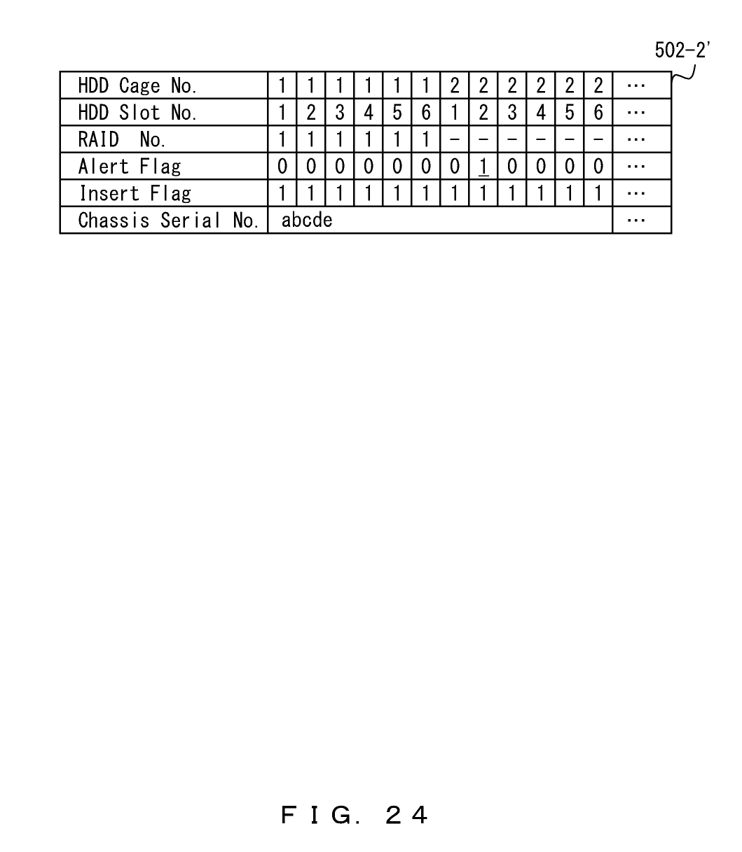

Thereby, the HDD configuration table 502-2 becomes an HDD configuration table 502-2′ as illustrated in FIG. 24.

After the termination of the check process, the BMC 315-2 starts the display process as illustrated in FIG. 16, detects HDD slot number=2 corresponding to alert flag=1 from among records with HDD cage number=2 in the HDD configuration table 502-2′, and detects that there exists an error in the slot 333-2-2. Because it is not possible to read the HDD position table 613-a from the HDD unit 601-a attached to the slot 333-2-2 (i.e., because data has not been written in the HDD position table 613-1), the BMC 315-2 determines that the type of the error is insertion omission. The BMC 315-2 reports, to the CPU 312-1, error information including the type of the error and the HDD cage number and the HDD slot number representing the slot of the insertion omission, and the CPU 312-1 displays error information in the display device 351-2.

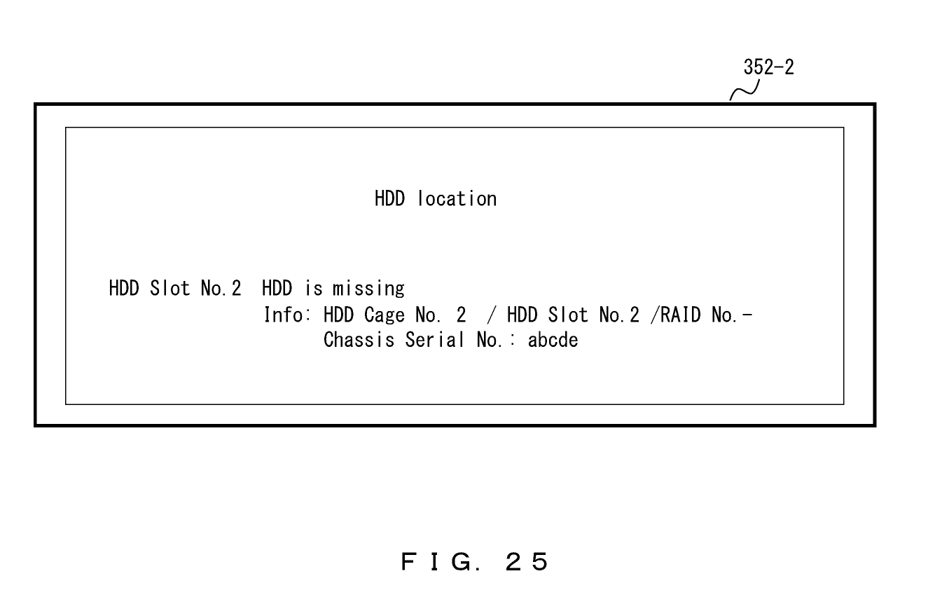

FIG. 25 illustrates a display window in case of detection of insertion omission.

In the display window 352-2, “HDD is missing”, which means that insertion omission has been detected”, is displayed. Also, in the display window 352-2, HDD cage number=2 and slot number=2 representing the slot 333-2-2 in which insertion omission has been detected and chassis serial number=abcde included in the HDD configuration table 502 are displayed.

The maintenance personnel removes the HDD unit 601-a from the slot 333-2-2 on the basis of the error information displayed in the display device 351-2, attaches the HDD unit 2-2, and resets the server 101. After resetting the server, the BMCs 315-1 and 315-2 again performs a check process and a display process, confirms that all alert flags are zero, and thereafter continues POST, and the update process illustrated in FIG. 17 is performed.

According to the information processing apparatus of the embodiments, it is possible to detect erroneous implementation of an HDD, to explicitly report it, and to prevent data from being deleted by unintended rebuild of RAID. Also, according to the information processing apparatus of the embodiments, it is possible to display a right slot to which an HDD that has been erroneously attached is to be attached. According to the information processing apparatus of the embodiments, it is possible to detect and display a slot to which an HDD that is to be attached to the slot has not been attached.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a plurality of slots into which a storage device container including a storage device and a first memory that stores first position information representing a slot to which the storage device is to be attached is inserted;
a second memory that stores configuration information including second position information representing a slot into which the storage device has been attached;
a controller that compares the first position information and the second position information and determines whether or not the storage device has been attached to a slot represented by the first position information, on a basis of a comparison result; and
a processor that outputs the first position information when the storage device has not been attached to a slot represented by the first position information.

2. The information processing apparatus according to claim 1, wherein
the controller compares the first position information and the second position information and determines that the storage device has not been attached to a slot represented by the first position information when the two pieces of information do not match.

3. The information processing apparatus according to claim 1, wherein
the processor displays the first position information and the second position information in a display device when the storage device has not been attached to a slot represented by the first position information.

4. The information processing apparatus according to claim 1, wherein
the configuration information includes insertion information indicating whether or not there is a storage device that is to be attached to each of the plurality of slots, and
the controller determines presence or absence of a storage device that is to be attached to each of the plurality of slots, on a basis of the insertion information.

5. An information processing method that is performed by an information processing apparatus including a plurality of slots into which a storage device container including a storage device and a first memory that stores first position information representing a slot to which the storage device is to be attached is inserted and a second memory that stores configuration information including second position information representing a slot to which the storage device has been attached, the information processing method comprising:
comparing, by a controller, the first position information and the second position information;
determining, by the controller, whether or not the storage device has been attached to a slot represented by the first position information, on a basis of a comparison result; and
outputting, by a processor, the first position information when the storage device has not been attached to a slot represented by the first position information.

6. The information processing method according to claim 5, wherein
the determining includes determining that the storage device has not been attached to a slot represented by the first position information when the first position information and the second position information do not match.

7. The information processing method according to claim 5, wherein
the outputting includes displaying the first position information and the second position information in a display device when the storage device has not been attached to a slot represented by the first position information.

8. The information processing method according to claim 5, wherein
the configuration information includes insertion information indicating whether or not there is a storage device that is to be attached to each of the plurality of slots, and
the information processing method further comprises determining presence or absence of a storage device that is to be attached to each of the plurality of slots, on the basis of a insertion information.
